(19) United States
(12) Patent Application Publication
(10) Pub. No.: US 2004/0142744 A1
(43) Pub. Date: Jul. 22, 2004

(54) Mobile data access

(75) Inventors: Keith W. Atkinson, Henderson, NV (US); Jeff Fiegel, Las Vegas, NV (US)

Correspondence Address: MARGER JOHNSON & McCOLLOM, P.C., 1030 S.W. Morrison Street, Portland, OR, 97205, US

(73) Assignee: Acres Gaming Incorporated, Las Vegas, NV (US)

(21) Appl. No.: 10/723,375

(22) Filed: Nov. 25, 2003

Related U.S. Application Data
(60) Provisional application No. 60/439,084, filed on Jan. 8, 2003.
(60) Provisional application No. 60/477,644, filed on Jun. 12, 2003.

(51) Int. Cl. G06F 17/00

(52) U.S. Cl. 463/29; 705/51

(57) ABSTRACT

Embodiments of the invention include a secure wireless data access system and ways to use such a system. Data from a game network is accessible over wireless devices that use a variety of security protocols to protect sensitive information of the game network. In addition to long encryption keys and hardware layer addressing, particular wireless devices are only allowed to be connected to the network at certain pre-defined times. Reports of unauthorized access can be generated immediately when any suspicious behavior is detected. One such way to use the described wireless data access system is for redeeming tickets, and for monitoring events of a gaming network as they occur.

### CROSS REFERENCE TO RELATED APPLICATIONS

This application claims priority from U.S. provisional application 60/439,084 entitled “System for Realtime Game Network Tracking”, filed Jan. 8, 2003, and “Mobile Data Access”, filed Jun. 10, 2003, (attorney docket number 4164-272), the contents of both of which are expressly incorporated herein for all purposes.

### TECHNICAL FIELD

This disclosure relates to networks of gaming devices, and, more particularly, to accessing data from the networks in a secure manner over a wireless network.

### BACKGROUND OF THE INVENTION

Gaming networks are communication networks of interconnected gaming devices. Typically, gaming networks include a collection of gaming devices, or EGMs (Electronic Gaming Machines) that are linked to a central server. As the EGMs are played, events occur that are tracked by the EGM, such as coins being deposited, buttons pressed, handles pulled, jackpots won, etc. The EGMs also store data in meters, such as value of coin in, total games played, total payout, etc.

The central server or servers can also store large amounts of data on databases, such as a player's history, (i.e., what games the player has played, at what times, etc.) number of loyalty points accumulated, accounting information about single and groups of EGMs, data about special promotions and bonuses, etc.

As can be seen, there are vast amounts of data present on the gaming network to be managed, logged and accessed.

Presently, data stored on the gaming network is typically accessed by logging onto a computer terminal that is wired to the network. Once logged in, different applications can be run that access data from the databases and elsewhere on the gaming network. Additionally, log files and summaries are prepared and, in some instances, printed for review by the gaming network operators.

Operating the terminal to retrieve data from the gaming network requires physical presence of an authorized user at the appropriate terminal. Because these terminals are relatively large, and are coupled to the gaming network through a cable, the terminals are fixed and not movable. Therefore, data from the gaming network can only be accessed in particular locations on a gaming floor. Although wireless data networks are becoming more widespread for some applications, like email, because of strict data privacy and security issues in gaming networks, no viable solution involving wireless networks is presently available.

Embodiments of the invention address these and other deficiencies in the prior art.

### BRIEF DESCRIPTION OF THE DRAWINGS

The description may be best understood by reading the disclosure with reference to the accompanying drawings.

FIGS. 1A and 1B together are a block diagram showing components of a gaming network according to embodiments of the invention.

FIG. 2 is a block diagram showing example components of a secure wireless network operating in conjunction with a gaming network, according to embodiments of the invention.

FIG. 3 is a chart illustrating different forms of security used in establishing and conducting wireless communication of data.

FIG. 4 is an example flow diagram illustrating an example flow for establishing communication between a wireless device and a wireless host on a gaming network.

FIG. 5 is a block diagram illustrating components of an example redemption server.

FIG. 6 is a screenshot of an example screen that can be shown on the redemption server of FIG. 5.

FIG. 7 is a screenshot of an example log screen that can be shown on the redemption server of FIG. 5.

FIG. 8 is an example flow diagram illustrating an example flow for redeeming tickets using embodiments of the invention.

### DETAILED DESCRIPTION OF THE PREFERRED EMBODIMENTS

Embodiments of the invention are directed to a gaming network that supplies data that can be accessed by devices over a secure wireless network. Wireless servers or hosts generate communication and data channel signals that are sent to wireless receivers used by casino operators or employees. Users of the wireless receivers establish a secure session with a wireless server running on the gaming network. Once the secure session is established, applications on the wireless servers can request data from the server and/or provide data to the server. For some applications, the data can be requested to service users of games on the gaming network.

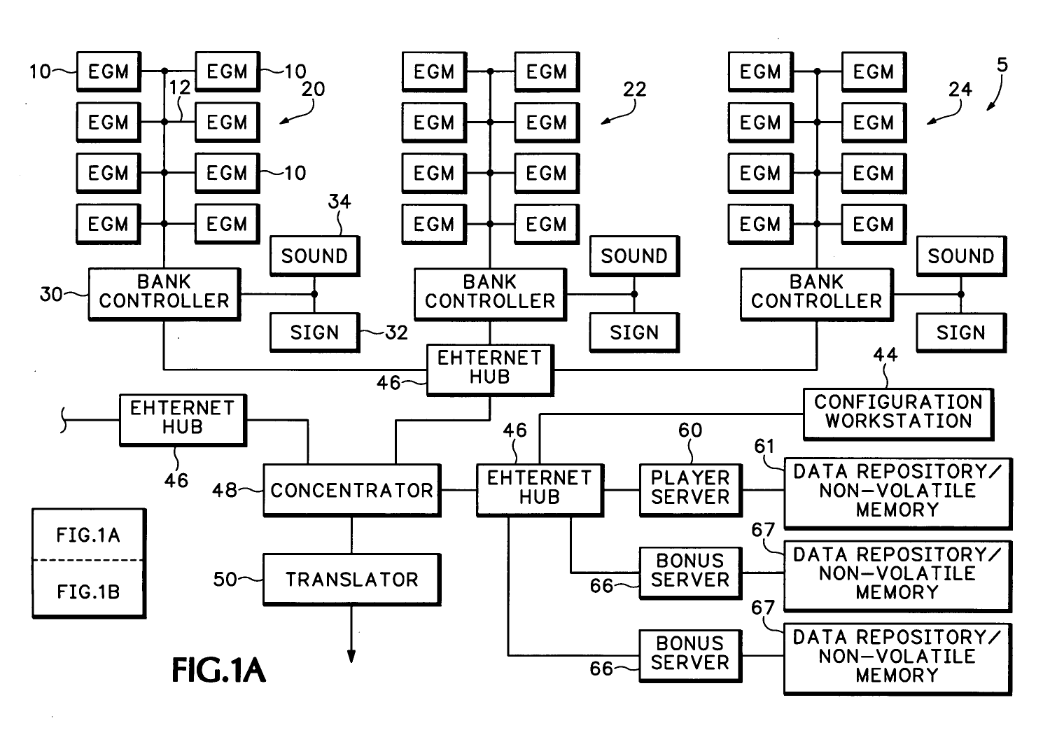

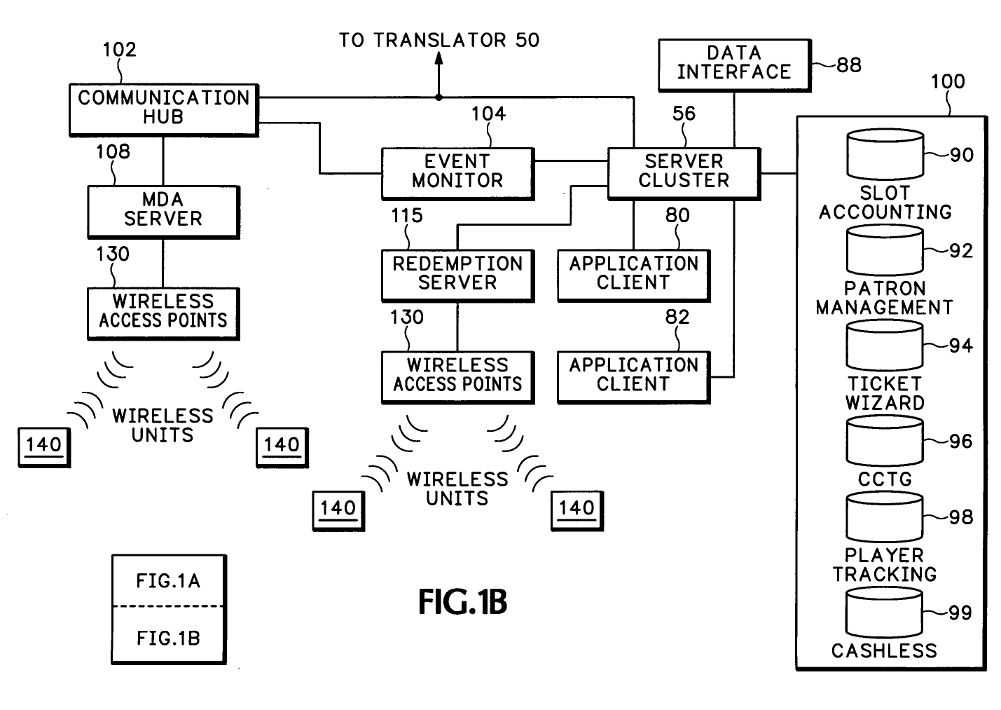

One such gaming network is illustrated in FIGS. 1A and 1B. In a gaming network 5, a number of EGMs 10 are organized in groups called banks. Individual banks 20, 22, and 24, can contain almost any number of gaming devices 10. Additionally, any number of banks is possible in a gaming network 5.

Each bank is controlled by a bank controller 30, which is coupled to each EGM 10 by a communication cable 12. The bank controller 30 facilitates data communication between the gaming devices 10 in its associated bank and the other components on the gaming network 5. In some embodiments, the bank controller 30 need not be present, and the EGMs 10 communicate directly with the other portions of the gaming network 5.

Configuration data for the gaming network 5 is stored in one or more network data repositories 61, 67. In some embodiments, the data repositories 61, 67 are made of battery backed-up non-volatile SRAM (Static Random Access Memory), which provides dual advantages of having extremely fast data input and output, and having a power source that is independent from the network 5 or the gaming devices 10. The data repositories 61, 67 may also be mirrored, i.e., duplicate copies are made in real-time. This prevents data from being lost if one of the battery sources should fail or other catastrophic event. Data is stored in the data repositories 61, 67 using CRCs (Cyclic Redundancy Checks) and timestamps to ensure the data is valid and non-corrupt.

Configuration data is created at a configuration workstation 44 and stored in the data repositories 61, 67. Configuration data includes message data for players as well as for promotions such as bonuses. Player message data is stored in the data repository 61, where it can be accessed by a player server 60. Player message data can include welcoming messages, card-in/card-out messages, and special messages about current promotions, for instance. The player server 60 reads the message data from the data repository 61 and sends a properly formatted message back to the bank controllers 30 and EGMs 10. These player messages may be displayed on a screen 32 for an entire bank, or may be shown on a screen directly mounted to the EGM 10 (not shown).

Other configuration data created at the configuration workstation 44 and stored in the data repositories 61, 67 includes casino configuration data, such as identification of each EGM 10 on a casino floor. Additional parameters stored in the data repository 67 are parameters used in promotions, such as bonus promotions. These parameters include such items as what EGMs 10 are included in the promotion, how to fund a bonus, i.e., if a bonus is funded by a portion of the coin-in amount of the EGMs 10, whether a paid bonus is to be taxed or un-taxed, and other parameters.

As players play the EGMs 10 in the gaming network 5, the EGMs send data from their coin meters, or meter values. One or more bonus server 66 stores these meter values, or summaries of the meter values, in its associated data repository 67. The bonus servers 66 can also operate based on the present and stored meter values to determine an amount of money being wagered on the EGMs in near real-time. The bonus servers 66 can use the amount of money being wagered to calculate bonus pools that are funded as a percentage of the coin-in of participating EGMs 10. For instance, the bonus servers 66 can calculate a present amount of a bonus pool that is funded at one-half of one percent of the coin-in for the participating EGMs 10. An example of bonus promotions that can be operated from the bonus servers 66 includes LUCKY COIN and progressive bonuses, for example.

Of course, the servers 60, 66, could be embodied in a single device, or in other configurations, and do not have to appear in FIG. 1A, which is only a functional representation. Likewise, the data repositories 61, 67 could be embodied in a single device.

As data is generated by the EGMs 10, data is passed through communication hardware, such as Ethernet hubs 46, and a concentrator 48. Of course, switches or bridges could also be used. The concentrator 48 is also coupled to a translator 50, which includes a compatibility buffer so that the data from the EGMs 10 can be used by a server cluster 56 (FIG. 1B), and other parts of the gaming network 5.

The server cluster 56 (FIG. 1B) may, of course, be embodied by more than one physical server box. In practice, including multiple server boxes with dynamic load sharing and backup capabilities of one another ensures the gaming network 5 is nearly always operational.

The server cluster 56 is attached to and manages several databases, such as a slot accounting database 90, a patron management database 92, a ticket wizard database 94, a “Cage Credit and Table Games” (CCTG) database 96, a player tracking database 98, and a cashless database 99. These databases are collectively referred to as the databases 100. Of course these databases 100 are only exemplary, and more or fewer databases can be part of the gaming network 5. In some embodiments, particular servers in the server cluster 56 manage a single database. For example, a single server in the server cluster 56 may manage the slot accounting database 90, while another server manages the patron management database 92. Such implementation details are well within the expertise of one skilled in the art. However, for ease of illustration, FIG. 1 shows a single server cluster 56 that is coupled to all of the databases 100.

In operation, the slot accounting database 90 receives and stores statistical and financial information about the EGMs, such as dates, times, totals, game outcomes, etc. The patron management database 92 stores information regarding identified players, such as how often and which games they play, how often they stay in the casino, their total loyalty points, past awards, preferences, etc. The ticket wizard database 94 stores data about tickets that are issued by the EGMs, such as payouts and cashout tickets, as well as promotional tickets.

The CCTG database 96 stores information about non-EGM 10 data in a casino. That data is typically generated by a client station (not shown) coupled to one of the bank controllers 30. The client station can be located in a casino cage or at a table game, for instance, and data generated by the client station is forwarded to the CCTG database 96 where it is stored. For example, data such as when and how many chips a customer buys, when a customer creates or pays off markers, when a customer cashes checks, etc. is stored in the CCTG database 96.

The player tracking database 98 is a subset database of the patron management database 92, and is used when data retrieval speed is important, such as for real time promotions and bonusing. The cashless database 99 stores information about payment options other than bills, coins, and tokens.

Application clients 80 and 82 couple to the server cluster 56, and can retrieve data from any or all of the databases 100. Application programs run on an application client 80, 82 to provide users information about the gaming network 5 and the casino in which the network is established and to cause functions to operate on the gaming network 5. An example application client 80 could include, for instance, an accounting server that allows queries and provides reports on financial and statistical information on single or groups of EGMs 10.

A data interface 88 presents a uniform interface to other applications and servers (not shown), and grants access to retrieve data from the databases 100. Typically these other clients or servers would not be controlled by the same entity that provides the other components of the gaming network 5, and therefore the data interface 88 grants only guarded access to the databases 100. Other components of the gaming network 5 of FIG. 1 are discussed in detail below.

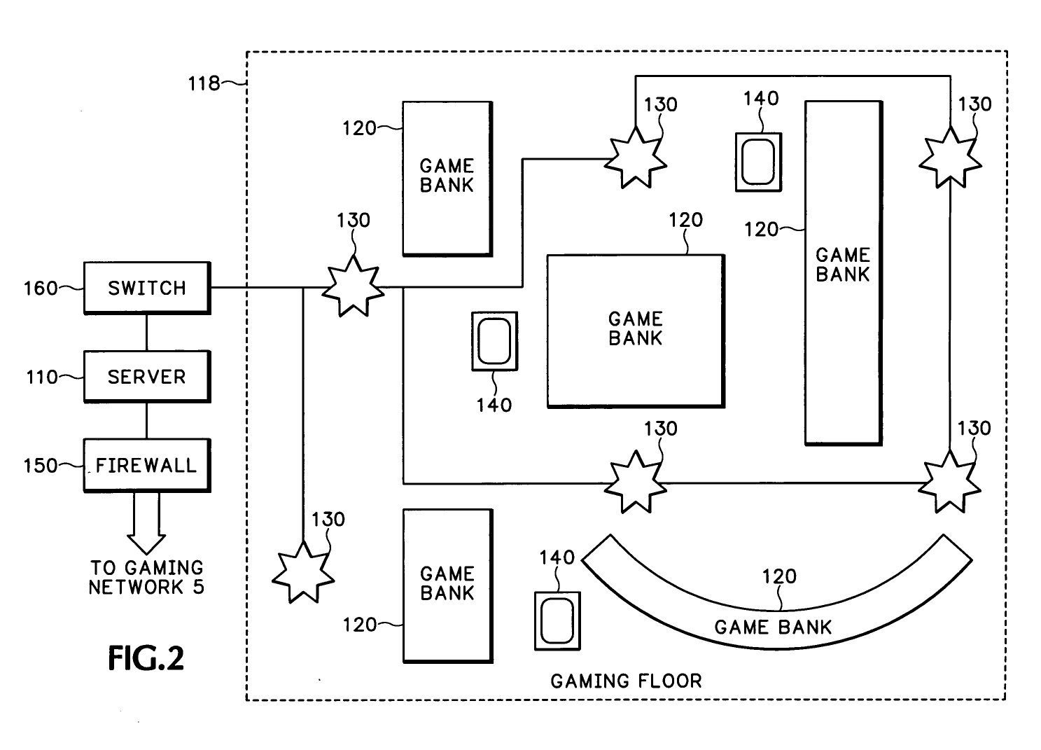

FIG. 2 is a block diagram of components of the gaming system according to embodiments of the invention. In FIG. 2, a gaming floor 118 is illustrated. The 5 gaming floor includes banks 120 of gaming machines. Several banks 120 are illustrated, although the number of banks on a gaming floor 118 could be as few as one (or simply a single EGM 10 not associated with any bank) or as many as is practical. Illustrated in FIG. 2 are five banks 120.

Also shown in FIGS. 1 and 2 are a number of wireless servers 130, also referred to as wireless access points (WAPs). The wireless servers 130 transmit and receive RF (Radio Frequency) signals over the gaming floor 118, thereby communicating with one or more wireless devices 140. Example wireless servers 130 are those that adhering to IEEE 802.11b, 802.11a, or 802.11g protocols, but any acceptable communication protocol could be used. The wireless servers 130 are connected to each other via wires or wireless links, as is known in the art. The wireless servers 130 and wireless devices 140 illustrated in FIG. 1 may be implemented as a same set of wireless servers 130 and wireless devices 140, or may, in fact, be separate systems, where the wireless devices 140 only communicate with a particular, and not all, wireless servers 130 in the game network 5. The wireless devices 140 both receive and transmit information to the wireless servers 130, as is known in the art.

The wireless servers 130 are distributed around the gaming floor 118 so as to cover as much of the gaming floor 118 with the RF signals as possible. In some instances, areas of the gaming floor 118 are covered with RF signals from more than one wireless server 130. In such a case, the wireless devices 140 typically automatically establish communication with the wireless server 130 that is nearest the particular wireless device 140.

The wireless servers 130 may be separated from the gaming network 5 by a firewall 150. A firewall is hardware and software operating to protect resources of a network. Specifically, the firewall 150 can be a tunneling firewall that encapsulates and encrypts data packets traveling between the wireless servers 130 and the firewall 150. An application server 110 can be used in conjunction with the wireless servers 130 on the gamefloor 118. Additionally, a switch 160 could be used to partition particular IP (Internet Protocol) or other addresses so the partitioned addresses are only available by the wireless servers 130, or the wireless devices 140 that couple to the wireless servers 130. Although illustrated outside of the gaming floor 118, the firewall 150, server 110, and switch 160 could all also be within the gaming floor 115. Their physical location is unimportant.

With reference back to FIG. 1, the application server 115 of FIG. 2 could be embodied by a Mobile Data Access. (MDA) server 108. The firewall 150 of FIG. 2 is not present in FIG. 1 but could, of course, be added between the MDA server 108 and the rest of the gaming network 5. In FIG. 1, the MDA server 108 connects to the gaming network 5 through a communication hub 102. The communication hub 102, in turn, is connected to the translator 50 and to an event monitor 104. The event monitor 104 is also coupled to the server cluster 56, which was described above.

The communication hub 102 collects data from the floor 118 as “events” when they happen and when they are reported by, for example, an EGM10. Events include, for example, doors to the EGMs 10 being opened, jackpots or other large amounts being awarded, etc. The event monitor 104 is connected between the connection hub 102 and the server cluster 56. In operation, the event monitor 104 combines live data from the communication hub 102 with historical data from one or more of the databases 100, and generates warnings, indications, and signals for someone monitoring the gaming network 5. For instance, the event monitor 104 will create a warning if the door to a particular EGM 10 is opened but no employee identification card has been inserted in that EGM10.

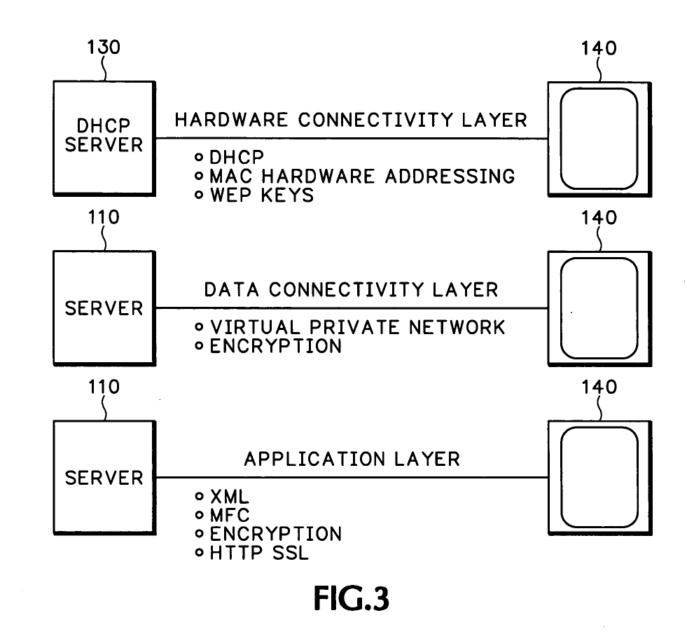

Operation of the wireless servers 130 and wireless devices 140 is described with reference to FIGS. 1, 2, and 3. Illustrated in FIG. 3 are different example levels of providing secure communication between a wireless server 130 or application server 110 and a wireless device 140. Of course, as described above, a wireless server 130 can communicate with many wireless devices 140 at the same time, as can the application server 110.

The lowest communication layer illustrated in FIG. 3 is a hardware connectivity layer. Any or all of the wireless servers 130 distributed about a game floor 118 can be a DHCP (Dynamic Host Control Protocol) server, or the DHCP server could be a program running on the application server 110. DHCP is a protocol that allows network administrators to centrally manage and automate the assignment of IP (Internet Protocol) configurations on a computer network. When IP protocols are used, each computer coupled to the gaming network uses a unique IP address. Therefore each wireless server 130 and each wireless device 140 has its own separate and unique IP address. Having a DHCP server alleviates the necessity to manage each individual IP address, and lets the DHCP server dynamically allocate the IP addresses when requested by devices attaching to the gaming network 5. The DHCP server makes IP configurations that are valid for a specific time period, called a lease period. During the lease period, those devices that are authorized to attach to the gaming network 5 are dynamically given an IP address to establish the communication.

In operation, the wireless network and the DHCP wireless units are assigned an ESSID (Extended Service Set Identifier), which identifies a wireless LAN. The ESSID of the wireless devices 140 must match the ESSID of the wireless servers 130 to establish communication. Typically, an ESSID is a 32-character case-sensitive string.

Further, the wireless server 130 and wireless devices 140 all operate on a particular frequency, or channel. As mentioned above, there are particular protocols on which wireless devices operate. Selection of a channel determines on which particular frequencies of a protocol the devices will operated. The wireless servers 130 and wireless devices 140 can all operate on the same channel.

An additional hardware connectivity level uses MAC (Media Access Control) addressing. A MAC address is a physical hardware address that uniquely identifies each computer node on the gaming network. When the wireless servers 130 are set up by the gaming network manager, they are set up to only establish communication with particular (known) MAC addresses. For instance, the MAC addresses of the wireless devices are entered into an authorized MAC address list in the wireless server 130. Only wireless devices 140 having MAC addresses that are on such a list are allowed to establish communication with the wireless servers 130. In this way, unauthorized wireless devices cannot communicate to the wireless servers 130 and are prohibited from receiving any data from the gaming network 5.

Furthermore, the wireless servers 130 and wireless devices 140 are configured with a particular WEP (Wired Equivalent Privacy) key codes. WEP is a security mechanism defined within the IEEE 802.11 standard and is designed to make the security of the wireless medium equal to that of a wired communication. The gaming network administrator defines a WEP key and all of the wireless devices 130, 140 are set with the same key. Access is denied to any wireless device that does not have the assigned key. WEP keys come in different lengths, such as 40, 64, and 128-bit key lengths. The longer the key lengths, the more secure the code.

In addition to hardware connectivity, the server 110 communicates to the wireless devices 140 through a secure data connectivity layer. Specifically, the server 110 and the wireless device 140 can be connected through a VPN (Virtual Private Network). VPNs typically use a tunneling procedure, which places a data packet within another packet. The outer packet provides particular routing information for the embedded packet. Additionally, the embedded packet can be encrypted for additional security. In such systems, only the VPN server and the client know the proper “keys” to unlock the packets. Even if unauthorized wireless devices could gain access to a data packet, because the data within the outer packet is additionally encrypted, the unauthorized device could not read any of the data.

In addition to secure hardware and secure data layers, the server 110 communicates to the wireless device 140 through secure data application layers, such as XML (Extensible Markup Language), HTTP SSL (HyperText Transfer Protocol Secure Sockets Layer), and using MFC (Microsoft Foundation Classes).

In operation, when a wireless device 140 communicates to one of the wireless servers 130, it must first have the proper frequency, channel settings, ESSID, WEP keys, and MAC address. If any of these settings are not correct, the wireless server prohibits access and, if possible, creates a log of the event. In some embodiments, the wireless device 140 can create an alert for casino personnel to investigate if someone is trying to hack into the secure network. Such an alert can be sent to an operator terminal at one of the bank controllers (FIG. 1), for example.

If the wireless device 140 has the proper frequency, channel settings, WEP key and MAC address, the DHCP server determines if the particular device should be allowed onto the wireless portion of the gaming network 5. A particular wireless device may only be authorized to log onto the gaming network 5 during particular times. The DHCP server monitors these actions and only allows the wireless device 140 to log in when so authorized. For instance, a particular device can be checked out to a particular employee. The DHCP server can be set up to allow a log in for that device only when that employee is scheduled to work. Or, the DHCP server can be set up to only allow a log in during the first 15 minutes of that employees shift. If the employee did not log in during that time period, the DHCP server could block any log in of that wireless device 140 until the employee met with a manager, who could re-enable the DHCP server to allow login. additionally, the DHCP server can be set up to automatically log out a previously logged in user who does not use the wireless device 140 for a period of time, for instance, for over 20 minutes. That prevents an unauthorized person from finding a misplaced wireless device 140 and taking advantage of the gaming network 5. Other detailed examples of using a wireless device are given below.

Further to those methods described above, data traffic from the wireless device 140 can be defined by its source, destination, protocol, and port, as is known in the art. Filtering, either by the DHCP server, or the server 110 itself can provide an additional level of security. For example, if the destination address of a packet is not an authorized destination, the server 110 can log out the particular wireless device 140 with the inaccurate destination address. Doing so provides additional security.

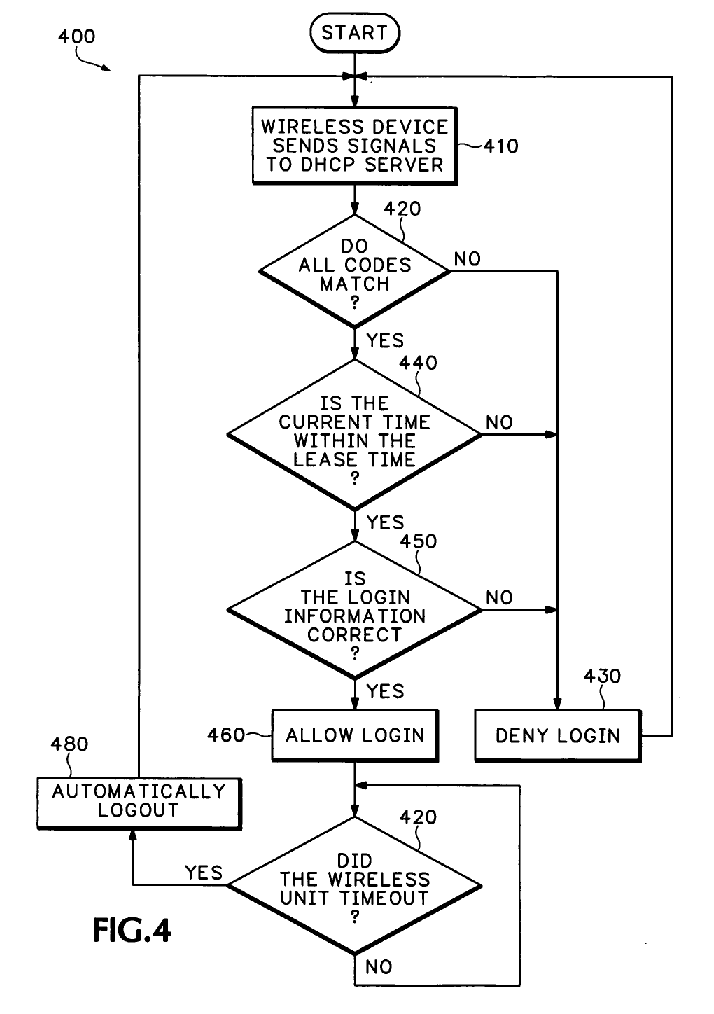

FIG. 4 is an example flow diagram illustrating processes that can be used in the gaming network 5 according to embodiments of the invention. A flow 400 begins at a process 410 where a wireless device 140 sends signals to the wireless server 130 to log into the gaming network 5. The wireless device 140 automatically sends its ESSID, WEP key, and MAC address over the proper frequency and channel to the wireless server 130. If these codes do not match what the wireless server 130 is expecting in a process 420, the wireless server 130 denies login of the wireless device 140 in a process 430. Additionally, an error log entry or alert may be generated (not shown). Otherwise, the wireless server 130 checks the particular wireless device 140 against the lease reservation times for when it should be accessing the gaming network 5. If the lease reservation time does not match the present time in a process 440, i.e., the wireless device is not pre-arranged to be on the gaming network at that time, the login is denied in the process 430.

If the reservation time matches the present time in the process 440, the wireless server 130 accepts the login and password information in a process 450. If that information is correct, the login is allowed in a process 460. Otherwise, the login is denied in the process 430.

Once the wireless device 140 logs into the network in the process 460, the flow 400 proceeds to a timeout loop process 470. If the wireless device never times out, i.e., it is accepting some type of input from an operator during every timeout period, the flow 400 will remain in the loop process 470, and the wireless device 140 will remain logged into the gaming network 5. If however, the wireless device times out, then the wireless server 130 or other server 110 on the gaming network 5 automatically logs out the wireless device in a process 480, and the flow 400 returns to the beginning. In this way, the gaming network 5 always maintains only those wireless devices that are authorized to be on the network, and that are continuously communicating with the gaming network 5.

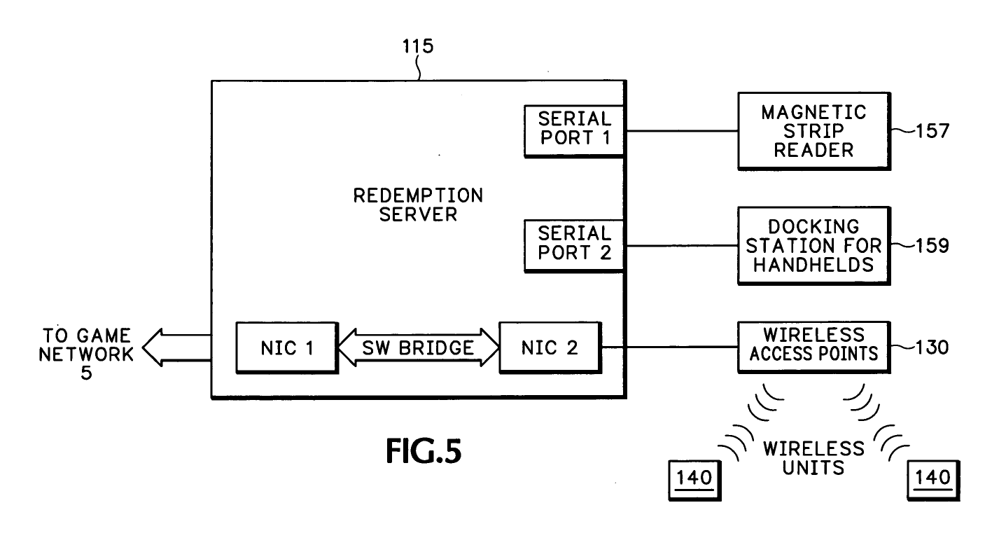

A standard procedure for providing employees with wireless devices 140 in a casino gaming network 5 could be as follows, as described with reference to FIGS. 1, 2, 5, and 6. In FIGS. 1 and 5, an exemplary application server 115, termed a “redemption” server, is shown. The redemption server 115 could be an embodiment of the generic server 110 of FIG. 2. Although only a single server 110 is illustrated in FIG. 2, in practice any number of servers 110 could be implemented. The redemption server 115 can couple to the gaming network 5 (FIG. 1) as shown in FIG. 2. Specifically, the redemption server 115 can couple to the server cluster 56, which provides access to the databases 100. In one embodiment, the redemption server 115 only couples to the slot accounting database 90 and the ticket wizard database 94.

The redemption server 115 primarily functions to redeem tickets or other redeemable rewards. Referring back to FIG. 5, included in the redemption server 115 are two NIC (Network Interface Cards) cards connected by a software bridge. One of the NIC cards, for example NIC 1 is coupled to and communicates with the gaming network 5, including being able to access the data stored on databases 100, for instance. The other NIC card, NIC 2, communicates with the wireless communication portion of the network. The NIC 2 is coupled to a wireless access point 130, which is also illustrated in FIGS. 1 and 2. A software bridge communicates requests and data from one network portion to the other.

Additionally included in the server 115 are two serial ports, port 1 and port 2. Serial port 1 is coupled to a magnetic strip reader 157, while serial port 2 is coupled to a docking station 159. The docking station 159, or cradle, can store one or more wireless devices 140. When a wireless device 140 is docked in the docking station 159, it can communicate to the server 115 through serial data communication through the serial data port 2.

Generally, for security and privacy reasons, an employee is assigned an individual wireless device 140 that they would “check out” at the beginning of a shift, or at other times. In one example checkout procedure, an employee would swipe their employee identification card at the magnetic strip reader 157. Of course, any identification procedure, such as bioinformatics, or a manual identification check by a manager could similarly be performed. Next the employee would remove the wireless device 140 from the docking station 159. A program running on the wireless device requests the employee to enter a PIN number, such as their employee PIN number or other number. The server 115 would match the PIN number to the strip code read from the strip reader 157 in a database stored on the server 115 or elsewhere on the gaming network 5. If the identification numbers match, the server 115 notes that the particular wireless device 140 is checked out to the employee.

In some embodiments, the server 115 can send an encryption key to the wireless device 140 through the serial port 2, while the wireless devices is docked in the docking station 159. In one embodiment, the encryption key is sent after the employee swipes their ID card in the swipe station 157, and before the employee removes the wireless device 140 from the docking station 159. The encryption keys are unique to each wireless device 140, of course.

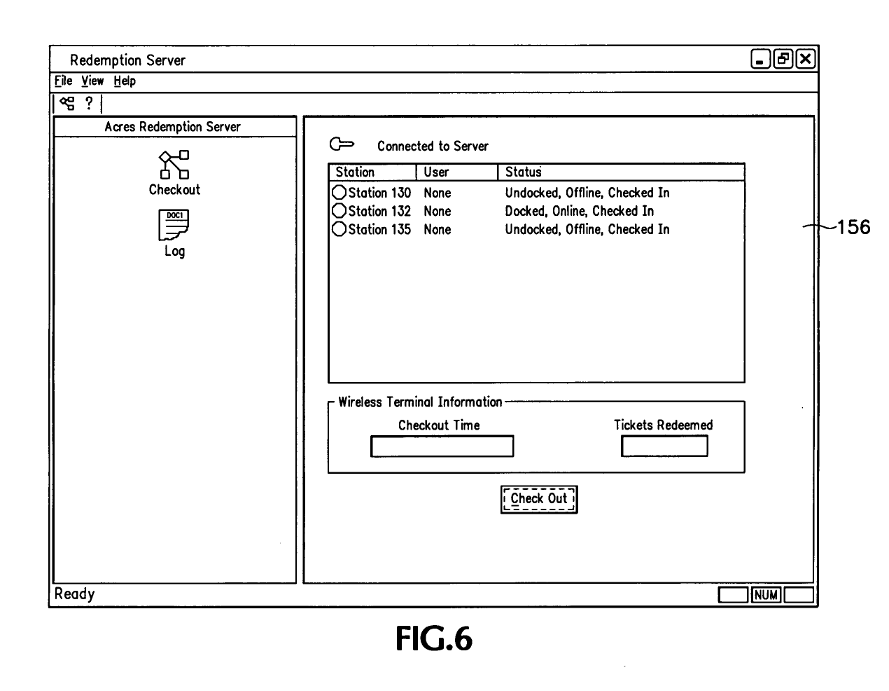

FIG. 6 illustrates a checkout screen 156 that can be shown in a window on the redemption server 115. Data reflecting a status of each wireless device 140 (illustrated as station 130, 132, and 135) is shown. Data such as whether a particular wireless device 140 is docked in the docking station 159, whether the device is checked in or checked out, and whether the device is communicating with the wireless server 130 (FIG. 2) can be shown on the screen 156. A wireless device 140 can be checked out using the process as described above, for instance. Once the PIN code is correctly entered on the wireless device 140, the checkout screen 156 updates the window to show that the particular wireless device had been correctly checked out. Similarly, once the wireless device 140 begins communicating with the wireless server 130, the checkout screen 156 reflects that the particular wireless device 140 is “online.” On the checkout screen 156, a color indicator signifies which state each wireless device 140 is in. For instance, a color indicator could show ‘red’ if a wireless device 140 is offline, ‘yellow’ if a device is either online or checked out, and ‘green’ if the device is both online and checked out. Of course, other color schemes are possible.

One way to check-in a wireless device 140, for example at the end of a shift, is for the employee to enter the wireless device back into the docking station 139, and swipe their ID card in the strip reader 157. The docking station 159 need not be the same station from which the wireless device 130 was originally checked out. Once finished, the checkout screen 156 would reflect the wireless device 140 as docked (because it was in the docking station 159), offline (because it was not communicating with the wireless server 130), and checked-in, because the check-in process had been completed.

Once a wireless device 140 is checked out, the device logs into the server 110. When logging into the server 110 from the wireless device 140, such as described above with reference to FIG. 4, a unit ID and network ID is associated within the gaming network 5 to the individual wireless device 140. This could be stored on the server 110 (FIG. 2), or elsewhere on the gaming network 5, for instance. After the employee has logged into the gaming network, a name, employee ID, session ID etc., could be linked to the previously stored data of the wireless device 140.

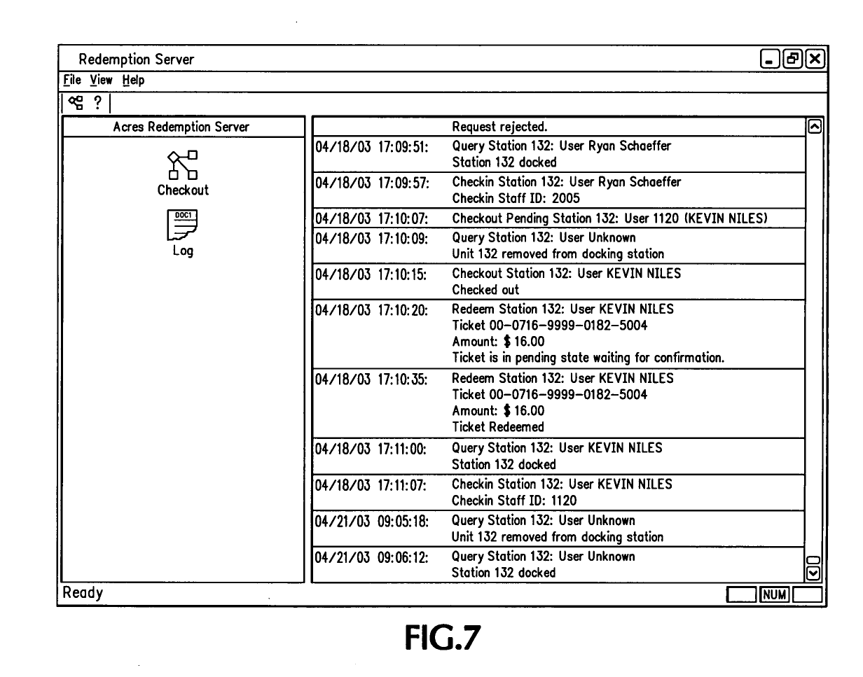

FIG. 7 illustrates a sample log table that can be generated for events relating to a wireless device 140. For instance, a timeline of a particular wireless device 140, which in FIG. 7 is labeled station 132, is illustrated. First, at 17:09:51, the station 132 is docked in the docking station 159 and then checked in at 17:09:57. The check-in was in response to the user (in this case “Ryan Schaeffer”) swiping his employee ID card at the magnetic strip reader 157. At 17:10:07, the user “Kevin Niles” swiped his employee ID card at the magnetic strip reader 157, indicating that he is going to check out the station 132. At 17:10:09 the station 132 is removed from its cradle, and at 17:10:15, the check out is completed by Kevin Niles keying in his PIN code into the station 132.

Because of its mobile ability, there are many ways to use embodiments of the invention in conjunction with a gaming network in a casino setting. One such way is to provide redemption of previously issued tickets. Tickets are printed forms of value, typically a cash representation, but they can also represent other forms of value, such as a coupon for goods or services, machine or bonus credits, or for other types of value.

Presently, to redeem a ticket a patron must present a valid ticket at a customer center, where there could be long lines. Using embodiments of the invention, a patron can redeem a ticket with a casino employee who has a portable ticket validator. The ticket validator could be an application or process operating on the wireless device 140.

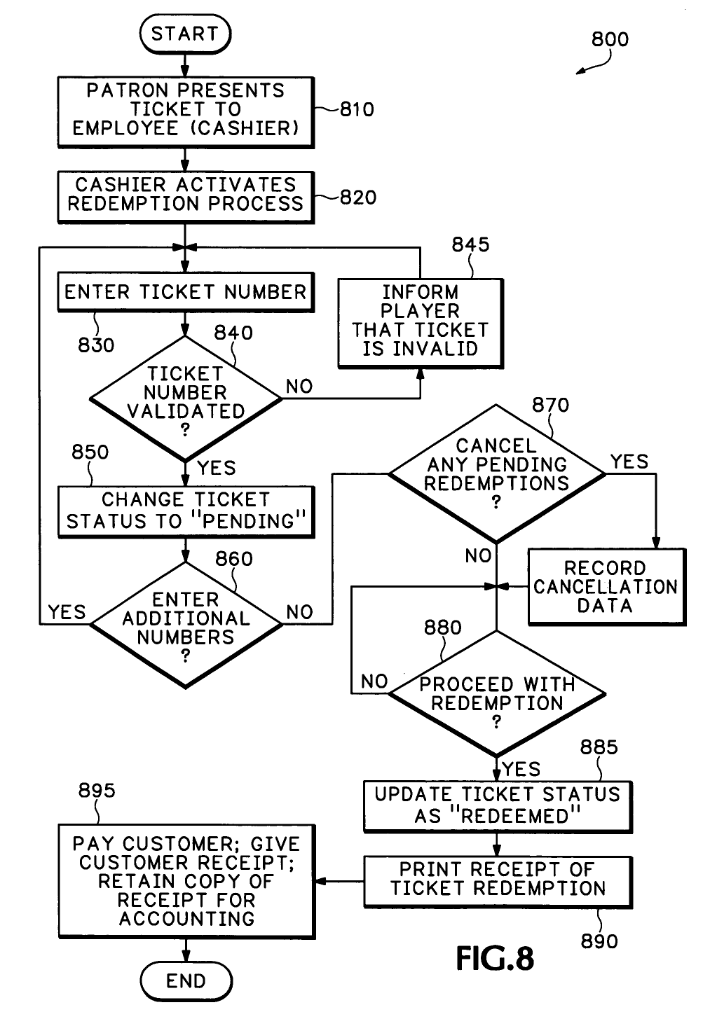

For instance, with reference to FIG. 8, a flow 800 begins at a process 810 by presenting a ticket to a casino employee, or cashier, who has a handheld or wireless device, such as the wireless device 140 described above. As mentioned above, the wireless device 140 operates a redemption process or program. In a process 820, the cashier begins the redemption process. In some embodiments, the cashier takes an action on the wireless device 140, such as by pressing a button or tapping a touch screen to initiate the ticket redemption.

Once the redemption process is begun, the employee enters the ticket number in a process 830. For instance, the wireless device 140 may have or be connected to a bar code reader, magnetic strip reader, or some other reader that can read a code on the ticket to be redeemed. Additionally, the cashier may be able to type in code numbers directly on the wireless device 140 to enter the ticket number. Other methods for entering ticket information could also be used.

Process 840 determines if the ticket number is a valid ticket number to be redeemed, i.e., is a valid entry in a ticket database, and a message is sent to the wireless device. If the ticket number is not valid, the cashier notifies the ticket holder in a process 845. If the ticket number is valid, an entry in a database holding the ticket information is changed from “not-redeemed” or an equivalent to “pending”, in a process 850. This event may also be logged, as illustrated in the entry at 17:10:20 in the log file of FIG. 7.

One problem that could prevent the entered ticket number from being validated is if the bar code or other type of reader was not operating properly at the wireless device 140. Of course, there is also the possibility that the ticket was made fraudulently, and therefore the ticket number cannot be validated by a corresponding database entry. Also, a player may unscrupulously try to photocopy, or otherwise made multiple copies of a ticket. Because, as described below, once a ticket has been redeemed it is marked as such in the gaming network 5, presenting a ticket that has already been redeemed is also another reason that a ticket number would not be validated.

If the cashier has multiple tickets to redeem, he or she can enter another ticket number before finishing redeeming the first ticket. That way, if a patron has several tickets they wish redeemed, the ticket numbers can be entered singularly, and then redeemed at the same time. A process 860 determines if there are additional numbers to enter. If there are additional numbers, the flow 800 loops back to enter the additional numbers.

A process 870 determines if any tickets already in the process of being redeemed are to be cancelled. If so, data concerning the cancellation is recorded, such as the date and time. In some embodiments, the database entry for the ticket number is never changed back to “cashable” from “redemption pending” or from “redeemed.” Preventing records from ever being updated in this manner prevents tickets from being redeemed multiple times, if an unscrupulous employee who had access to the database were to change the database entry back to “cashable.”

When the cashier is ready to proceed, he or she identifies the particular tickets to be redeemed and makes an indication to complete the redemption, such as by pressing another button or clicking another icon. The flow 800 then exits the loop formed by the process 880, and updates the ticket status as “redeemed” in the database in a process 885. Other information, such as date and time of the redemption as well as the cashier performing the redemption is also recorded and stored. A sample log file entry is shown at time 17:10:35 of FIG. 7.

A receipt of the redemption is printed in the process 890, and in a process 895, the redemption is completed by paying the customer and giving them a receipt of the transaction. The handheld wireless device 140 could have a receipt printer built in, for instance. The receipt could include information such as the date, time, amount, location, wireless device identification, casino employee information, batch session, for example.

In some embodiments, the ticket redemption system described above works in parallel with hand ticket redemption. For instance, in the process 840 if the ticket number is not validated, but the cashier knows that it is a valid ticket, then the cashier could redeem the ticket as a “manual pay.” In such a situation, the cashier would maintain a copy of the manual pay receipt, as well as the redeemed ticket, and the transaction could be reconciled at the end of the shift with proper accounting.

Other scenarios in which such a system as described above could include redeeming jackpots, either with or without a ticket. In one embodiment, when a customer wins a jackpot, a jackpot ticket prints. A casino employee could go directly to the machine that had the jackpot and process the jackpot ticket as described above with reference redeeming a ticket in FIG. 8. If the amount of jackpot winnings were above the threshold where the government requires documentation, such documentation could be entered by the cashier at the machine itself, using the handheld wireless device. Then, in addition to printing a receipt for the transaction, as described in the process 890 of FIG. 8, the wireless device 140 could also print any necessary tax forms at the same time, and give the appropriate forms to the winning player.

To redeem a jackpot without the gaming device having had printed a ticket, the cashier having a wireless device 140 could go to the gaming device that won the jackpot. Then, the cashier could enter all of the necessary information, received directly from the player or from the gaming device itself. Once authorized by the gaming network 5 over the wireless device 140, the cashier could pay the jackpot, give any necessary receipts, and retain appropriate accounting transaction receipts.

Totals for tickets processed, time spent logged into the network, etc., can be stored on the server 110 (FIG. 2) or elsewhere on the network, which could allow casino management to measure the performance of particular casino employees.

Although examples of machines and processes have been described herein, nothing prevents embodiments of this invention from working with other types of machines and processes. Implementation of the secured mobile data access is straightforward in light of the above description. As always, implementation details are left to the system designer. The specific circuits, functions, and procedures used to securely access data from the gaming network may be implemented in any way, with any components, without deviating from the spirit of the invention.

Thus, although particular embodiments for accessing data using mobile devices in a secure manner have been described, it is not intended that such specific references be considered as limitations upon the scope of this invention, but rather the scope is determined by the following claims and their equivalents.

What is claimed is:

1. A gaming network comprising:
a plurality of gaming machines;
one or more information servers coupled to the plurality of gaming machines, the one or more information servers structured to store data related to the plurality of gaming machines and related to players of the gaming machines, and to generate data for use on the gaming network;
a secure wireless server coupled to the one or more information servers; and
a secure wireless receiver structured to couple to the secure wireless server and to create a secure data channel between the wireless server and the wireless receiver.

2. The gaming network of claim 1 wherein the wireless server is structured to create a session with the secure wireless receiver.

3. The gaming network of claim 2 wherein the session is limited in duration.

4. The gaming network of claim 2 wherein the session can only be established in certain time periods.

5. A system for redeeming tickets comprising:
one or more information servers on a gaming network, the one or more information servers configured to store data related to past play of gaming machines and related to players of the gaming machines, and to generate data for use on the gaming network;
data stored on the one or more information servers relating to transactions previously memorialized by a ticket;
a secure wireless server coupled to the one or more information servers;
a secure wireless receiver structured to couple to the secure wireless server and create a secure data channel between the wireless server and the wireless receiver over which data stored on the one or more information servers can be retrieved.

6. The system of claim 5, further comprising a session detector configured to determine if the secure wireless receiver has a presently established session with the secure wireless server.

7. The system of claim 5, further comprising a ticket validator configured to determine if a particular ticket identifier correctly identifies a previously memorialized transaction.

8. The system of claim 7 wherein when the ticket identifier correctly identifies a previously memorialized transaction, the one or more information servers are configured to generate redemption data.

9. The system of claim 8 wherein the redemption data includes the date and time a ticket was redeemed.

10. A method for securely communicating data over a wireless portion of a gaming network, the method comprising:
establishing a secure data channel between a wireless device and a wireless server;
after the secure data channel established, establishing a data session between a wireless device and a server on the gaming network; and
transmitting data from the gaming network to the wireless device.

11. The method of claim 10 wherein establishing a secure data channel comprises:
sending a privacy code and a hardware address from a wireless device to a wireless server; and
authenticating the privacy code and hardware address.

12. The method of claim 11, wherein establishing a secure data channel further comprises:
ensuring a current time according to the gaming network is within a predetermined valid lease time in which the wireless device is allowed to communicate with the gaming network.

13. The method of claim 10, further comprising disabling the secure data channel after the wireless device timeouts from the gaming network.

14. A method for completing a transaction over a secure wireless information network, comprising:
establishing secure communication over a wireless network to a gaming network between a wireless server and a wireless device;
accepting an identification of the transaction at the wireless device;
verifying the identification is valid;
verifying that a portion of the transaction has already occurred;
verifying the transaction has not been completed; and
when the identification is verified as valid, a portion of the transaction is verified as having occurred, and the transaction is verified as having not been completed, generating data memorializing the completion of the transaction.

15. The method of claim 14 wherein the portion of the transaction that has already occurred is memorialized by a printed ticket.

16. The method of claim 14 wherein generating data memorializing the completion of the transaction comprises recording a present date, time, and location.

17. The method of claim 16, further comprising storing the present date, time, and location on the gaming network.

18. The method of claim 14 wherein generating data memorializing the completion of the transaction comprises recording an identification of the wireless device.

19. The method of claim 15 wherein the identification of the transaction is printed on a ticket.

20. The method of claim 19 wherein the identification of the transaction is encoded in a bar-code.
